(19) United States
(12) Patent Application Publication
(10) Pub. No.: US 2018/0260885 A1
(43) Pub. Date: Sep. 13, 2018

(54) System for Shopping Assistance

(71) Applicants: Tyler Binafard, Beverly Hills, CA (US); Shahab Binafard, Beverly Hills, CA (US)

(72) Inventors: Tyler Binafard, Beverly Hills, CA (US); Shahab Binafard, Beverly Hills, CA (US)

(21) Appl. No.: 15/917,543

(22) Filed: Mar. 9, 2018

Related U.S. Application Data
(60) Provisional application No. 62/469,042, filed on Mar. 9, 2017.

(51) Int. Cl. G06Q 30/06; G06Q 20/12; H04W 4/024

(52) U.S. Cl. CPC G06Q 30/0639; H04W 4/024; G06Q 20/12; G06Q 30/0641

(57) ABSTRACT

Exemplary embodiments described herein include a system for participating and assisting in the distribution and sale of goods.

### PRIORITY

This application claims benefit of U.S. Provisional Patent Application No. 62/469,042, filed Mar. 9, 2017, which is incorporated by reference in its entirety herein.

### SUMMARY

Exemplary embodiments described herein include a system for participating and assisting in the distribution and sale of goods.

### BRIEF DESCRIPTION

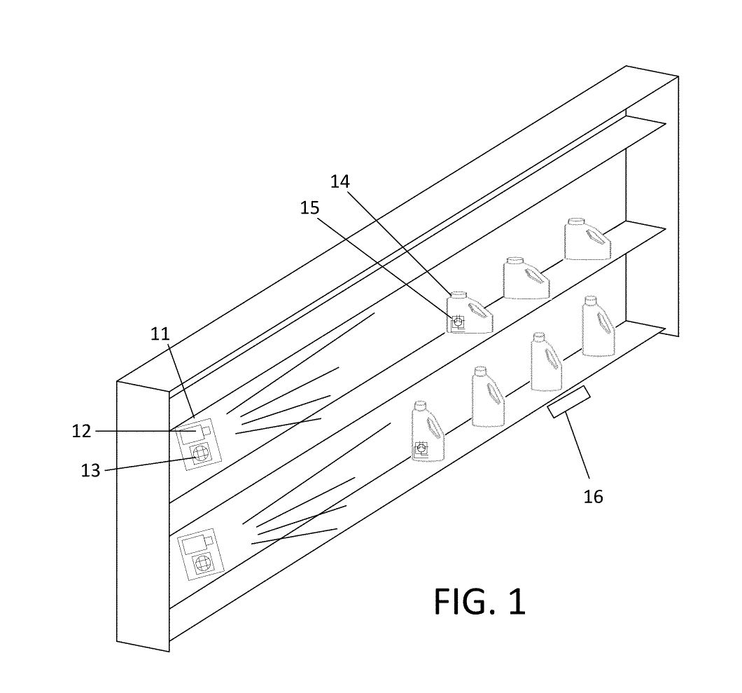

FIG. 1 illustrates an exemplary in store inventory system according to exemplary embodiments described herein.

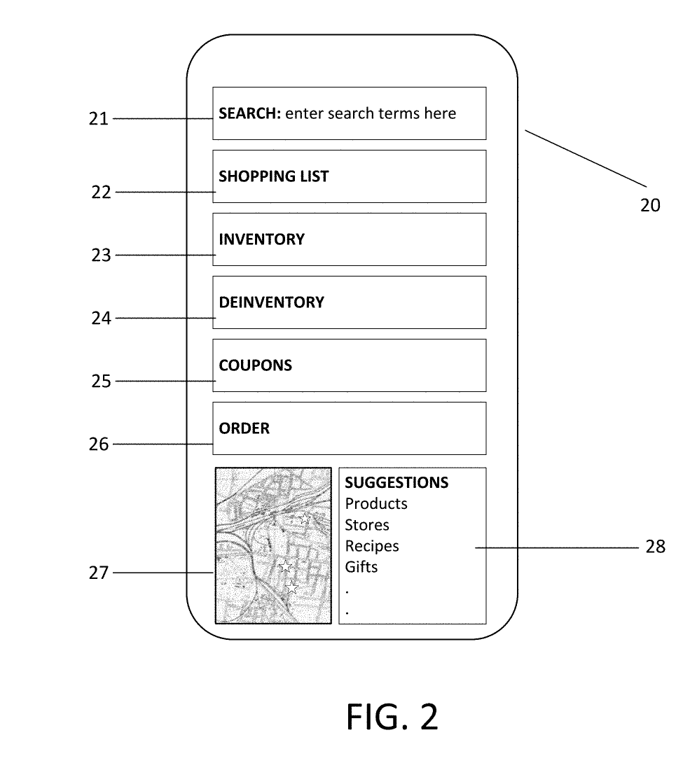

FIG. 2 illustrates an exemplary user interface according to exemplary embodiments described herein.

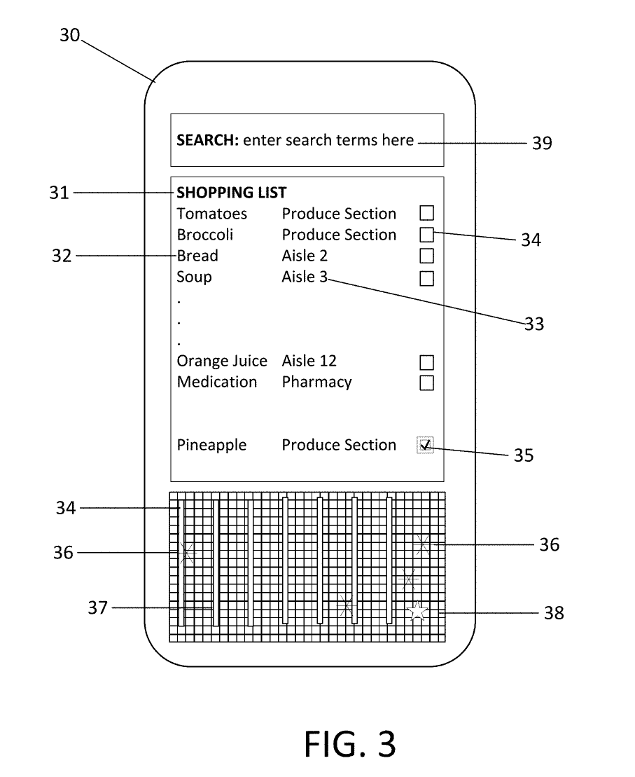

FIG. 3 illustrates an exemplary user interface for the shopping application for use in a store location according to exemplary embodiments described herein.

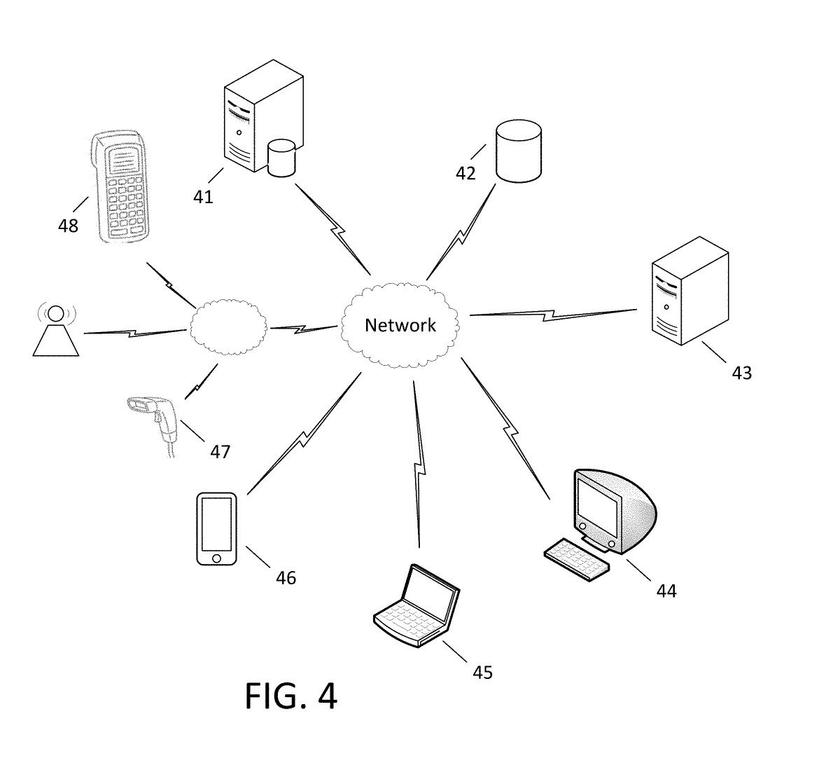

FIG. 4 illustrates an exemplary system configuration according to embodiments described herein.

### DETAILED DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention, and are not limiting of the present invention nor are they necessarily drawn to scale.

Exemplary embodiments described herein include a system for participating and assisting in the distribution and sale of goods. The system may include a customer application, a store application, a server having a processor and memory for storing non-transitory machine readable medium that when executed by the processor performs functions described herein. The application(s) may communicate with a server from an electronic device. The application may be a program stored as non-transitory machine readable medium on memory of the electronic mobile device and executed by a processor to perform one or more functions described herein. When the code is executed, the application may provide a user interface, presented to a user through an output device, such as, but not limited to, a screen, located on the electronic device. The application may also accept information from the user via an input device such as, but not limited to, a keypad, button, touchscreen, camera, etc., located on or communicating with the electronic device. The application may communicate information between the server and the electronic device through a network connection. The application may receive, store, display, and/or communicate information such as, but not limited to, a location of the user, one or more items desired by the user, image, product information, scan identifier, payment method, payment information, identification, prior purchasing history, and any combination thereof. The application may also communicate information such as, but not limited to, an identity of a store, a map, grid, or location plan associated with the store, a location for the one or more items, directions on locating the one or more items from the server to the user, other suggested retail items, customer ratings, product descriptions, promotional information, inventory, price information, alerts, coupons, discounts, and any combination thereof. The system may include electronic devices such as computers, mobile devices, signal transmitters, signal receivers, camera, scanner, display, input devices, communication devices, and combinations thereof.

Exemplary embodiments include an application to assist a shopper in creating, managing, organizing, and prioritizing their purchasing decisions. The application may be stored in memory of a user's mobile device and when executed by a processor present the user with a user interface to input and receive information. The application may store the received information in a database, either locally or remotely. The application may communicate with a remote server to provide additional information to the user. The additional information may include any information relevant or related to the information entered by the user. For example, additional information may include prices, store locations, alternative products, additional products, discounts, coupons, advertisement, nutritional information, and any combination thereof. Exemplary embodiments include an application to assist stores in maintaining inventory.

FIG. 2 illustrates an exemplary user interface 20. The user interface may be used to provide and retrieve information to a user. In an exemplary embodiment, the user interface of FIG. 2 illustrates an example for a shopper application.

In an exemplary embodiment, the shopper application is configured to permit the user to conduct a search of items. The user interface may include a search input 21 that permits a user to enter search criteria. The search criteria may be entered, such as, for example, via a text box, radio button selection, drop down menu, or other user input for selecting or defining the search criteria. The search criteria may permit a user to search for and select a particular product.

In an exemplary embodiment, the shopping application may be configured to store a user selection. The shopping application may include a shopping list 22 that tracks the products needed by a user.

In an exemplary embodiment, once a search is conducted, the shopping application may permit a user to provide additional search criteria to narrow the results. In an exemplary embodiment, a selection may be provided of additional subcategories to select. For example, if a user enters “tomatoes”, the system may provide the user with a list of options including, fresh tomatoes, organic tomatoes, canned tomatoes, tomato sauce, etc. The user may make a selection, and the item added.

The shopping application may be configured to parse the shopping list for convenience, cost savings, availability, other criteria of interest to the shopper, and combinations thereof. For example, the shopper may define a list of ten items that are needed. The shopping application may be configured to subdivide the list based on the proximity of stores and/or the availability of items within stores. Therefore, the shopping application may subdivide the list in three, where four items are within a first list associated with a first store, five items are associated with a second list associated with a second store, and a final item is associated with a third list associated with a third store. The lists may be defined based on a price comparison of stores within a set proximity. The shopping application may subdivide or present the items by particular store locations, such as grocery items and hardware store items and craft store items, etc. The shopping application may be configured to subdivide lists based on user inputs and preferences, such as cost savings, consolidating locations (reducing the number of stores), avoiding certain stores, preferring certain stores, proximity to a certain location or locations, and any combination thereof. The shopping application may permit a user to prioritize preferences and/or provide thresholds for preferences. For example, a store within 5 miles is preferred and if items are found within 5 miles then price is a priority, but when a location is required over 5 miles then the user places a higher priority on consolidation of locations over price.

In an exemplary embodiment, the system may identify locations where identified products are sold 27. The system may present a map or a list of stores that may have the entered items. The system may be configured to communicate with inventory systems to determine whether products are available.

In an exemplary embodiment, the system may store and present the list as a consolidated list or as a separated list. Therefore, the user may choose to view their entire list to review their identified items. They may also review their lists as segregated by a given criteria, such as location or product type.

In an exemplary embodiment, the system may permit a user to enter information to maintain an inventory of items 23. For example, the user may look up items as described herein and enter products within an inventory. The shopping application may also retrieve information from a data input from the electronic device running the shopping application to retrieve information. For example, the shopping application may be configured to run on a mobile device of the user. The shopping application may use the camera of the mobile device to retrieve an image of a product. The shopping application may be configured to recognize a product from the image. The image may include a logo, name, bar code, container, identification number, and combinations thereof to identify a product from the image. Other inputs may also be used, such as infrared scanner, Bluetooth, radio frequency, etc.

In an exemplary embodiment, the inventory information may track items that the shopper already has in their possession. The input used to inventory items may also or alternatively be used to identify items for their shopping list. For example, when an item is used, the user may scan a bar code on the product to identify the product to the shopping application. The shopping application may automatically add the item to the shopping list or may prompt the user whether the item should be added as inventory or as a shopping list item.

Similar to the inventory system, the shopping application may permit a user to de-inventory items when they are used up or no longer in the user's possession. Similar to the inventory description above, an item may be de-inventoried by entering the item into the shopping application and identifying that it should be de-inventoried. The shopping application may present the user with the list of inventoried items, such that the shopper may identify which items to de-inventory. The shopping application may also receive a description of a product, such as by search, or entry of an identification number or image or other method described herein. The shopping application may also receive an indication the product should be de-inventoried, or may request such indication from the user. The system may automatically de-inventory items based on conventional shelf life of items.

In an exemplary embodiment, the system may use the inventory and/or the lists to identify other products for a user or make other suggestions or associations for the user. For example, the shopping application may suggest recipes (and therefor other products needed to complete the recipe) based on items already in the possession of the user and/or items to be purchased for the user. For example, if the user is purchasing spaghetti, the application may suggest recipes for tomato meat sauce or meatballs. The application may be configured to receive preferences and inputs from the user for making or narrowing suggestions the application provides for the user. The application may make suggestions described herein in real time response to an input from the user (such as after a search item, suggesting brands for the searched item) or may provide a user interface for providing such suggestions when the user is interested in receiving them.

In an exemplary embodiment, the system may provide the user with information related to searches conducted or items entered into their lists. For example, the system may provide the user other suggestions 28. These suggestions may be on other items to use in place of products selected. For example, if a user enters tomatoes and selects tomato sauce, the system may suggest brands of tomato sauce. If a user selects a specific brand of tomato sauce, the system may identify alternative brands, or provide coupons, discounts, or other marketing related to the selected or other brands of tomato sauce. The shopping application may also suggest stores in which to purchase the entered products. The shopping application may also suggest other products related to the entered product. For example, if the user entered tomato sauce, the shopping application may suggest related products such as spaghetti, bread, etc.

In an exemplary embodiment, the shopping application may permit the user to directly purchase one or more of the entered products. The shopping application may therefore permit a user to order products 26. The user may request to order products from an identified store and the products shipping to a designated location. The user may request to order products and have the products saved or ready for pick up at or after a designated time. The user may retrieve the products from the store and simply pay for the items directly before leaving the store, thereby bypassing a conventional check out checker.

In an exemplary embodiment, the system may coordinate between an inventory aspect, the shopping list aspect, the purchase aspect and combinations thereof. For example, when a user identifies an item as being needed the item is cross-referenced against the inventory list. If it is in the inventory list, the application may automatically de-inventory the item or prompt the user to de-inventory the item. The prompt may be used as a reminder that the user has the item and may therefore not need to replace the item. The system may add items to inventory that are indicated as purchased.

In an exemplary embodiment, the system may be configured to store or provide promotions to the user. For example, the user may store coupons 25. The system may permit the user to enter coupon information, download coupons, store electronic coupons, take pictures of coupons, or combinations thereof to store discounts related to items within their list. The shopping application may therefore provide an inventory system of user coupons and identify coupons relevant to items within the consumer list. For example, if the consumer compiles a lot of coupons and has tomato sauce within their list, the shopping application may suggest a specific brand based on one or more coupons the customer has available for use.

In an exemplary embodiment, the shopping application may provide suggestions to the user. The suggestions may be based on the previous actions of the user, the aggregated actions of system users, product promotions by specific brands or companies, or other criteria. The system may use any recognizable pattern to make suggestions or provide additional functionality to the system. In an exemplary embodiment, the shopping application may be configured to track and identify correlations between information by the user, or aggregated across users, or from entered or recognized information from other sources.

In an exemplary embodiment, suggestions may be based on previous actions of a user. For example, the shopping application may recognize a correlation between products. If the user generally buys products together, such as diapers and baby wipes, the application may suggest the other when one is entered. As another example, the system may recognize a duration between resupply, such that the system may suggest a purchase of a product after a determined duration. For example, the user may typically resupply shampoo every month. The system may suggest the user resupply at, before, or around a month. The system may present a list of items that are likely to be renewed based on a previous propensity of a user to resupply on a certain duration. For example, the system may have a coming due for resupply that identifies items that are likely going to be required within a specified duration that permits the user to easily select such items and add them to their list.

In an exemplary embodiment, suggestions may be based on product placement or promotions supported by a specific brand, company, store, friend, or combinations thereof.

In an exemplary embodiment, the shopping application is configured to share one or more items or lists with another user. For example, households may share a list such that one or more persons within a residence may add items that are needed. In an exemplary embodiment, the sharing may be at an item level, may be uni-directional, or may be bi-directional. For example, a child may have an instance of the shopping application on their mobile device and may add items to a shopping list. The shopping list may be related or shared with a parent of the household. The items entered on the child's list may automatically be received within the parent's shopping list or may require approval or confirmation before being added to the parent's shopping list. However, the parent's shopping list may or may not be similarly provided to the child's shopping list.

Users may identify products for one or more shopping list. The shopping lists may be defined or created by one or more tags associated with an item in a list. The tag may indicate a list that is defined by the user. The user may set criteria based on the defined list. For example, the share attributes of the product may be defined by the identified list. Other attributes may include purchase preferences (such as location verses price), sharing attributes, priority of purchase (i.e. whether it is to be purchase on the next time at the store or later), location, product type, etc. The system may track one or more tags or identifiers with a given product such that an item may appear on one or more lists.

FIG. 3 illustrates an exemplary user interface 30 for the shopping application for use in a store location. The shopping application may be used to identify products 32 within a list 31, a specific location of the product 33, indicate when the product is retrieved 35, may provide location information for the product 34, may organize a list based on location, provide promotional materials to a user, provide product information (such as nutritional data, ingredients, customer reviews, etc.) and combinations thereof.

In an exemplary embodiment, the shopping application may include a user interface to display a list 31 to the user including the products 32 within the list. The list may be all of the items desired within the retail store location or all of the items within a user list.

The application may be configured to identify a store location and retrieve location information for the list items within the store. For example, the mobile device used to execute and display the shopping application may include a location system, such as GPS. The system may use the GPS coordinates, or other location methods (such as triangulating through cellular towers), to locate the user and determine that a user is at a specific store location. The application may then retrieve store information and related product information to determine product location within a store. The application may retrieve store layout or floorplan information to map product locations within the store.

In an exemplary embodiment, the user interface may include an input such that the user may indicate when an item is retrieved. As shown in FIG. 3, the application displays a box proximate the identified item. The user may touch or select the box 34 to indicate that the item has been retrieved. The display may change 35 to indicate that the product has been retrieved. The retrieved item may be relocated within the list or removed from the displayed list to indicate that the product has been retrieved.

In an exemplary embodiment, the shopping application is configured to guide a user through a retail location. The application may be configured to retrieve product item location information and order the displayed list in response to the location information. The retrieved location information may be from any available source, such as the inventory system described herein.

In an exemplary embodiment, the shopping application is configured to display a location of a product to a user. The display may be represented as a map 34. The map may include a layout of the store location including location of store aisles 373. The desired products may be marked on the map within a vicinity of the product location such as by overlaying an icon 36 on the map 34. In an exemplary embodiment, the user's present position may also be indicated on the map, such as by another icon 38. In exemplary embodiments, the application may be configured to communicate with in store location or positioning system to provide higher precision or provide location information within the store location.

In an exemplary embodiment, the application may include a user input for adding additional items to the list. For example, a search box 39 may be provided for a user to search for additional products. In this way, if the user finds a product in store that was not originally on the list, the user may search for it and add it to the list. The user may then benefit from other features of the system, such as inventory and check out, and keep track of all items retrieved during the shopping experience. Other input may also be provided or used, such as the product scanner or image recognition. In an exemplary embodiment, the product look up feature may be used to provide product information and/or add the product to the list. Product information may include nutritional information, material or ingredient information, product reviews, etc. The product look up may also permit the user to retrieve promotional information about the product or related products. For example, if the user is looking for the cheapest brand of tomato sauce, the user can scan any brand and retrieve promotional discount information about competitor brands. The user may then select the promotion and add the item to their list.

In an exemplary embodiment, the application may provide notifications to a user of related or promotional information. For example, the application may recognize that the user is proximate to or will pass a product within the store. The application may provide the user pop up or other displayed information about the product. The application may communicate with the location system to identify a location of the user within the store. The application may be configured to provide marketing material or promotional alerts when a user having a predefined characteristic (such as search history, item in their list, demographic information, etc.) is proximate a promoted product. The application may communicate with a beacon at or proximate the product to receive an indicator to provide a notification regarding the promoted product. The beacon may be configured to provide the details to retrieve the promotion information or may provide the promotional information to the application to display to the user.

Exemplary embodiments of the system may permit retail stores to inventory their products. Similar to the inventory system identified above, the system may permit store locations to track inventory and/or product location information to communicate with the shopping application. The store may use the shopping application or may use a store application that communicates with the user shopping application. The store applications may have any combination of features described by the shopping application.

In an exemplary embodiment, the store application may be configured to track product inventory. The product inventory may be tracked based on the items received and the items sold. For example, the store application may permit a user to enter in a product description and the number of products received. The product entry may be through a scanner, such as a bar code scanner of the product. The product entry may be through a look up such as that described herein. The product entry may be through entering a product identifier, such as a SKU number. The store application may be configured to communicate with registers and/or register scanners to identify when a product has been sold. The store application may be configured to track the received and sold items to determine an amount of inventory at any time. In an exemplary embodiment, the store application may permit a user to enter in a store inventory at any time. For example, a user may count products on hand and enter in the number within the system. The entered number may act as a check against the tracked amount, may override the tracked amount, and/or be used instead of tracking an amount.

In an exemplary embodiment, the store application may be configured to store the location of a product within the store. The location of the product may be at a general product category. For example, cereal may be on aisle 1, while chips are on aisle 5. The shopping application may then retrieve this location information and use it to determine a location within the store of the products within a user list. The system may permit a hierarchy of store locations within the system. For example, the store application may permit a user to enter in general product description locations at different levels of specificity. The system may then use a product location based on the most specific criteria. Specifically, the store may permit a user to identify snack food is at aisle 5-6, while chips are on aisle 5, while a specific brand of chips may be at an aisle end. When a user enters in chips, the aisle 5 location may supersede the more general snack food location, but not the specific brand location. If the user enters the specific brand, then the specific location may supersede the general chip location. The store application may be configured to retrieve and store any level of location specificity, such as aisle location, shelf number, location along the aisle, etc.

In an exemplary embodiment, the store application may communicate with transmitters and/or receivers within the store to retrieve inventory information. For example, FIG. 1 illustrates an exemplary in store inventory system according to exemplary embodiments described herein. The store inventory system may include a transceiver 11 comprising a transmitter 12, receiver 13, or combinations thereof. The transceiver may be configured to recognize, communicate with, send signals to, receive signals from products 14 on the shelf and any combination thereof. The product 14 may include an identifier 15 that is recognized by the transceiver 11.

In an exemplary embodiment, the transceiver may be a camera that retrieves images of products on the shelf. The transceiver may communicate the retrieved images to a remote location for processing or the transceiver may be configured to retrieve the image and determine a product within the image and/or an amount of product within an image. The product and/or amount may be determined using image recognition software. The product and/or amount may be determined using an identifier recognition, such as a symbol on the product (e.g. identifier 15).

In an exemplary embodiment, the transceiver may use a signal to determine the product and/or amount of the product. The signal may include optical signals, radio signals, infrared signals, magnetic signals, electromagnetic signals, and combinations thereof. For example, radio frequency identification (RFID) may be used and an RFID tag positioned on the product (such as identifier 15) and the transceiver is configured to identify a product or product count by a signal received by the RFID signal from the identifier. Transceivers may be positioned at one or more locations along a shelf or shelf system.

In an exemplary embodiment, other detection systems may be used with the inventory system. For example, weight may be used to determine the presence and or quantity of a product. The system may therefore include weight sensors and communication devices to detect and send information about the weight and/or product count to the system.

In an exemplary embodiment, the inventory system may be used to identify location information of products within the store. For example, if a first transceiver identifies a number of products on a shelf, the system may relate the first transceiver (and the corresponding identified products) to a specific shelf location. If a second transceiver identifies a number of products on a shelf, the system may related the second transceiver (and then the corresponding products identified by the second transceiver) to another specific shelf location. The store may therefore be monitored by a plurality of transceivers, in which each transceiver has a known location. The location of the transceiver may be used to identify a location of the items the transceiver identifies and/or detects. The inventory system may therefore determine a product and/or product count and update the system accordingly. This information may then be retrieved and used by the shopper through the shopping application.

In an exemplary embodiment, the system may be configured to notify a user when a product is misplaced. For example, when a shopper picks up an item, but returns it to an incorrect location, the system may identify the product through one or more embodiments described herein. The detected item may be determined as being mislocated, such as by using the system checks described herein (e.g. comparison to other locations having products of greater quantity, or comparison to previously locations identified for the product). Once identified as being a mislocated item, the system may provide a notification to the store through one or more user interfaces that the product is misplaced and identify the product and/or the location of the misplaced item. Notices may be through the application user interface, email, text message, or other notification system.

In an exemplary embodiment, the system may update on periodic intervals to reduce or may be updated in real time. In an exemplary embodiment, the system may update a store application in real time, while updating a user application on intervals. The system may also have conflict resolution priorities such that the system does not identify a location of a loan product as the location for the product within the store. For example, the system may have a backup general location description of products. Therefore, when a product is detected on an aisle that it does not belong to, the detected item may not be used to update the location information for that product, thereby reducing the probability that shoppers are sent to the incorrect location based on stray misplaced items. In addition, the system may compare previous location information and/or check against multiple location information to resolve conflicts. For example, if a product is found at more than one location, the system may then look to see how many are at each location and use the location with more product at that location or may use the location that is in common with the most recent last saved location for that product.

In an exemplary embodiment, signals may be stored within product identifiers 16. These product identifiers may include transceivers according to descriptions provided herein. The product identifier may also include beacons such that a user through the shopping application may receive notices and or location information about desired or promoted products. The product identifier may also include location beacons to position a user within the retail store.

In an exemplary embodiment, the system may include stand-alone look up devices. For example, an electronic device may be provided in the store having a user interface to entering a product description into the device. The stand-alone look up device may be configured to present a user interface similar to the shopping application in retrieving product identification and/or suggesting products to the user for selection. The stand-alone look up however may provide the user with store location information about the product or other product information such as price, ingredients, customer ratings, etc. Therefore, if a user does not have the application, the user may still benefit from item location through the stand-alone device.

FIG. 4 illustrates an exemplary system configuration according to embodiments described herein. Any combination of the disclosed features is within the scope of the instant disclosure. The application(s) described herein may be run on any electronic device. Exemplary electronic devices include a computer 44, a laptop 45, and a mobile device 46. The application(s) may prompt the user, via the output device (such as a screen), to input information into the input device (such as a touch screen or key board/mouse). The application may send this information to a database 42 through the server 43 over a network. The application may also retrieve information from the database from the server and display information to the user via the output device. The server and database may be integrated 41 and/or distributed 42, 43. Parts of the server and database may reside on the electronic device itself. The system may also communicate with other electronic devices such as a scanner 47, monitor or beacon 49, or input device 48. The system may also use local networks or relays to communicate with a larger network or system, such as the internet.

In an exemplary embodiment, the mobile device may include a geolocation device such as, but not limited to, a global positioning system (GPS) receiver. The application may accept information on the location of the user from the GPS receiver. The application may send information on the location of the user to the server via a wireless network connection, such as the mobile network or Wi-Fi network. The server may then identify a specific store associated with the geographic location as determined from a look up in the databased communicating with the server. The server may identify one or a plurality of stores the user may be in and the application may present the list of stores to the user via the output device. The user may then select a specific store via the input device.

In an exemplary embodiment, the application may provide a prompt to the user, requesting information regarding a location of the user.

In an exemplary embodiment, the application running on the mobile device may identify the store. For example, the application may be store specific such that launching the application identifies the associated store. The application may be for a plurality of stores such as a chain and a frequented store is identified as a specific store, or the user may identify one store from a list of stores. The application may identify the store by combination of location mechanisms on the phone (such as GPS, mobile triangulation from cell towers, etc.), user input or selection, application specific information, communication from third party or network (for example a look up from a mapping program), a beacon or other identifier physically in the store providing an identifier, and combinations thereof. In this case, the application may provide the specific store identifier to the server to retrieve the requested information on product description, product location, etc.

In an exemplary embodiment, the application may provide a prompt to the user to enter information regarding specific items the user is looking for. The application may send this information to the database via the wireless network. The application may prompt the database to store the information regarding specific items until the user is in a store, or the application may store items. The application may therefore act as a store shopping list to be kept until the user physically visits the store. Once the user is in a store, the application can communicate the store information (or other information that can be used to identify the store by the server), the product information, other required information, and combinations thereof. The application may then retrieve information regarding a specific store layout (or an identification of which layout to use from stored layouts on the mobile device), location of each item from the database, and combinations thereof. The application may provide the user information regarding the specific location of each item and directions to each item.

In an exemplary embodiment, the application may provide the user with a graphical representation of the specific store layout, a location of the user, and the specific location of each item. The application may provide the user with a map of the store, an indicator for where the user is, and an indicator for the location of each item. The application may provide a depiction of a path from the location of the user to the location of each item on the map. The application may provide alternative or additional visual representation to determine the location of the item. For example, the user interface may display a directional image, such as an arrow, for the direction of the item. The image may be color coded or sized or may include textual representation (such as an alpha-numeric) to provide an idea of distance to the desired item.

In an exemplary embodiment, the application may provide the user with turn-by-turn directions, detailing the directions for the user to take in order to locate the specific item.

In an exemplary embodiment, the application may provide auditory information regarding the location of each item to the user.

In an exemplary embodiment, the application may provide the user general information regarding the specific location of each item, such as, but not limited to, an aisle number and shelf number.

In an exemplary embodiment, the application may display a desired combination path for determining the most efficient way to traverse the store. For example, the location of the items may be determined and a path of least distance determined to retrieve each item and enter and leave the store. The application may display a desired combination path based on priorities defined by the products to be purchased. For example, a priority may be identified to retrieve frozen items last. The priorities may be predetermined or entered/selected by a user. The priorities may be selected based on the items entered to retrieve. For example, if no frozen items are identified, the request to prioritize based on this condition would not be provided to the user. However, if a frozen item is identified in the list, then the application may prompt the user for a yes/no prioritizing the item to be retrieved last. Priorities may also or alternatively be preconfigured through a user preference or settings portion of the application.

In an exemplary embodiment, the application may provide suggestions of additional items to the user based on the specific items the user is looking for, and/or from past purchases.

In an exemplary embodiment, the application may provide the user with information on each of the specific items the user is looking for. This information may include, but is not limited to, product descriptions and reviews.

In an exemplary embodiment, the application may integrate with other applications on the mobile device. This may allow the application to provide information such as, but not limited to, the price of each of the specific items at various stores, reviews on each of the specific items, and alternatives to each of the specific items.

In an exemplary embodiment, the application may provide additional information to a user. For example, the application may provide alternative brand options, price comparisons, promotional or coupon opportunities, suggested products, and combinations thereof.

In an exemplary embodiment, the application may prompt the user to provide information on a payment method. The application may provide the payment method to the server and the server may store the information on the database. The application may use a list of the specific items the user is looking for in order to provide a total cost of the items. The application may provide a prompt for checkout based on the total. The application may use the payment method in order to complete a purchase of the user.

In an exemplary embodiment, the application may provide a virtual shopping cart. The virtual shopping cart hold any items the user selects and places into the virtual shopping cart. The application may provide a checkout screen that may accept information about the user's payment method. One or more payment methods may be pre-stored and selected by the user at a time of checkout. A default payment method may be used if no selection or entry is made. The application may use the user's payment method from the checkout screen to complete a purchase for the user.

The application may be configured to add items to the virtual shopping cart by scanning or imaging products or identifying features or otherwise by entering products, SKU codes, or other identifying feature from the physical product as the product is put in the user's physical cart. The application may be configured to add items to the virtual shopping cart by allowing the user to enter or select item information or select from a menu or search result. For example, once the user has navigated to an item, the user may select the item and move to their virtual shopping cart.

The virtual shopping cart may be used during the physical experience of shopping at the location or prior to arriving at the store. For example, the user may pre-select desired items for purchase. The items may be mapped for the user to retrieve. The user may also pre-purchase the items, and the store personnel retrieve the items and have the ready for pick up. In this case, at some time after the purchase is complete, the user may pick up the items at a selected store. The application may provide a notification to the user when the purchased items are ready for the user to pick up in the store. The user may be able to pick up the selected items in the store. As such, the application may allow the user to purchase items virtually and pick up the purchased items in a store. Therefore, the user may complete a purchase without being required to stand in a line in a store. The application may allow the user to purchase items virtually either before the user enters the store or while the user is inside the store.

In an exemplary embodiment, the application may communicate with a point of sale to identify products to be purchased. In this case, the purchase may be completed by conventional methods. However, the time to scan and check out may be greatly reduced. In an exemplary embodiment, the application may communicate with a user input to identify and confirm when a product is put in the user cart, and a desire to purchase is made. For example, the application may retrieve a digital image of the product, product label, product SKU, or other information, such as from the camera of the mobile device. The application may receive a user input identifying a product placed in the cart.

Although embodiments may be described and illustrated herein in terms of an application operating on a mobile device, it should be understood that embodiments of this invention are not so limited, but are additionally applicable to other computing devices such as, but not limited to, a desktop computer, a laptop computer, a tablet, a personal digital assistant, and a mobile phone.

Although embodiments may be described and illustrated herein in terms of an network connection, which is understood to include mobile communication, Wi-Fi, internet, local area network (LAN), Bluetooth, infrared, shortwave radio, radio frequency identification (RFID), or other communication protocols.

The application may relay the information accepted from the user in the search input to the server via the network. The server may then access a database in order to populate a list of items that may be similar to the description in the search input. The system may then relay the information from the server through the network to the mobile device. The application may display the list of items on the output device, such that the user may select which of the items he or she wishes to purchase. The suggested list may also be generated locally at the mobile device by the application or by accessing one or more third party applications or systems, such as the internet or internet search engine.

In an exemplary embodiment, a method of using the system is provided. The method may begin when the application is opened on the mobile device. Once the application is opened, the location of the user may be determined, this can occur by either the application using a geolocation device, such as but not limited to a GPS receiver, in the mobile device, the application prompting the user to enter the current location of the user, receive location information from a beacon within the store, other location determining method, or any combination thereof. The application may also prompt the user to enter one or more specific items the user is looking for or retrieve a list of one or more previously stored items. This may occur at any time before or after the user location is determined. Once the application has received the one or more specific items the user is looking for, the application may send this information to a server. The server may communicate with a database in order to retrieve information on the location of each of the one or more specific items. The server may relay the information back to the application to be displayed to the user. The application may provide the user with the location of each of the one or more specific items through a representation such as, but not limited to, a graphical representation, an auditory representation, or any combination thereof. The application may also provide the user with information on the location of each item relative to the location of the user. The application may update the information on the location of each item relative to the location of the user, such that as the location of the user changes, the information on the location of each item relative to the location of the user may also change.

Exemplary embodiments are provided herein as examples only. A person of skill in the art would appreciate variations exist that remain within the scope of the disclosure, and the claims should not be so limited. For example, a server is illustrated herein as a single computer system having its own memory for storing information, such as a database and non-transitory machine readable instructions. However, a server may include a distributed system in which multiple computer devices and components are working together. Therefore, a server should not be so limited as to require only a single processor and memory in direct communication within a single housing, although such a configuration is also included within the scope of exemplary servers. Similarly other recitations such as references to a processor or memory are not restricting such recitations to a single or only processor or memory or other component part. Instead, each may also include one or more component. Accordingly, any combination of features and components should be understood to be within the scope of the instant disclosure. Any component or combination of components may be integrated, subdivided, duplicated, added, removed, or otherwise combined and remain within the scope of the instant disclosure. Moreover, no single feature or component is integral or required. The customer application may be used within the inventory application, for example, and vice versa.

As used herein, the terms “about,” “substantially,” or “approximately” for any numerical values, ranges, shapes, distances, relative relationships, etc. indicate a suitable dimensional tolerance that allows the part or collection of components to function for its intended purpose as described herein.

While some specific embodiments have been shown, the disclosure is not to be limited to these embodiments. For example, most functions performed by electronic hardware components may be duplicated by software emulation, and vice-versa. Thus, a software program written to accomplish those same functions may emulate the functionality of the hardware components in input-output circuitry.

What is claimed is:

1. A system comprising:
an application stored in memory and configured to run on an electronic device;
a server; and
a database;
wherein the database comprises information on a location of one or more items;
wherein the application is configured to:
display a user interface; and
send information to the database through a network and the server, and receives information from the database through the network and the server.

2. The system of claim 1, wherein the application is further configured to:
receive information from a user related to one or more items into the user interface; and
display information on the location of the one or more items in relation to a store.

3. The system for shopping assistance of claim 2, wherein the application receives information on a location of the user.

4. The system for shopping assistance of claim 3, wherein the application provides a graphical representation of the location of the one or more items in relation to the location of the user.

5. The system for shopping assistance of claim 3, wherein the application provides an auditory representation of the location of the one or more items in relation to the location of the user.

6. The system for shopping assistance of claim 2, wherein the application populates a list of one or more suggested items relating to the one or more items.

7. The system for shopping assistance of claim 2, wherein the database further comprises:
additional information relating to the one or more items;
wherein the additional information comprises reviews, price, alternatives, and locations of the one or more items; and
the application presents the additional information via the user interface.

8. The system for shopping assistance of claim 2, wherein the application prompts the user for entry of a payment method;
wherein the application stores the payment method in the database;
wherein the application calculates a total cost of the one or more items; and
wherein the application applies the payment method to the total cost of the one or more items.

9. The system of claim 1, wherein the application is further configured to detect the presence of a product on a shelf

10. The system of claim 9, wherein the system comprises a transceiver for detecting the presence of a product on a shelf.

11. The system of claim 10, wherein the transceiver is configured to communicate with the server over the network and update an inventory of the product based on the detected presence on the shelf.

12. A system for shopping assistance comprising:
an application;
a computing device;
a network;
a server; and
a database;
wherein the application comprises a user interface;
wherein the database comprises information on the location of one or more items;
wherein the application runs on the computing device, sends information to the database through the network and the server, and receives information from the database through the network and the server;
wherein the application prompts a user for entry of the one or more items into the user interface; and
wherein the application prompts the user for information on a location of the user and the application accepts the information and provides the user with information on the location of the one or more items in relation to the location of the user.

13. The system for shopping assistance of claim 12, wherein the application provides a graphical representation of the location of the one or more items in relation to the location of the user.

14. The system for shopping assistance of claim 12, wherein the application provides an auditory representation of the location of the one or more items in relation to the location of the user.

15. The system for shopping assistance of claim 12, wherein the application populates a list of one or more suggested items relating to the one or more items.

16. The system for shopping assistance of claim 12, wherein the database further comprises additional information relating to the one or more items;
wherein the additional information comprises one or more reviews, a price, one or more alternatives, and one or more locations of the one or more items; and
the application presents the additional information via the user interface.

17. The system for shopping assistance of claim 13, wherein the application prompts a user for entry of a payment method;
wherein the application stores the payment method in the database;
wherein the application calculates a total cost of the one or more items; and
wherein the application applies the payment method to the total cost of the one or more items.
